(19) United States
(12) Patent Application Publication
(10) Pub. No.: US 2026/0009561 A1
(43) Pub. Date: Jan. 8, 2026

(54) HOT WATER TANK, METHOD FOR MANUFACTURING THE SAME, AND WATER HEATER

(71) Applicant: MITSUBISHI ELECTRIC CORPORATION, Tokyo (JP)

(72) Inventors: Kota KURIHARA, Tokyo (JP); Ryusei YAMAGUCHI, Tokyo (JP)

(73) Assignee: MITSUBISHI ELECTRIC CORPORATION, Tokyo (JP)

(21) Appl. No.: 19/133,721

(22) PCT Filed: Jan. 30, 2023
(86) PCT No.: PCT/JP2023/002832

§ 371 Date: May 29, 2025

(51) Int. Cl. F24H 1/18; F24H 9/40

(52) U.S. Cl. CPC F24H 1/181; F24H 9/40

(57) ABSTRACT

A hot water tank includes a body, a first part, and a weld formed by welding of the body and the first part to each other. The body is made of a corrosion-resistant material other than austenitic stainless steel.

### TECHNICAL FIELD

The present disclosure relates to a hot water tank, a method for manufacturing the hot water tank, and a water heater including the hot water tank.

### BACKGROUND ART

In the past, materials having corrosion resistance that do not degrade even when being welded have been desired as materials for hot water tanks that store water containing chlorides. For example, Patent Literature 1 discloses austenitic stainless steel as the material for a vessel that comes into contact with, for example, clean water or sewer water. In the composition design of the austenitic stainless steel described in Patent Literature 1, a weld having a solidification structure that does not allow ferrite layers to densely pack easily is formed. Therefore, the austenitic stainless steel described in Patent Literature 1 is expected to prevent degradation of corrosion resistance that is caused by a Cr-depleted layer, and thus also maintain excellent corrosion resistance at the weld.

### CITATION LIST

### Patent Literature

Patent Literature 1: Japanese Unexamined Patent Application Publication No. 2003-64453

### SUMMARY OF INVENTION

### Technical Problem

From the viewpoint of the manufacturing costs of hot water tanks, in some cases, it is desired that less expensive materials are used as materials for hot water tanks. However, hot water tanks of water heaters are required to have a certain level of corrosion resistance even in the case where they are made of inexpensive materials

The present disclosure is applied to solve the above problems, and relates to a hot water tank that can maintain corrosion resistance at a weld while reducing the manufacturing cost, a method for manufacturing the hot water tank, and a water heater including the hot water tank.

### Solution to Problem

A hot water tank according to an embodiment of the present disclosure includes: a main body; a first part; and a weld formed by welding of the main body and the first part to each other. The main body is made of a corrosion-resistant material other than austenitic stainless steel.

A method for manufacturing a hot water tank according to another embodiment of the present disclosure includes: forming a main body of the hot water tank that has a tank body having a cylindrical shape, using a coiled material of ferritic stainless steel or a coiled material of duplex stainless steel that is a mixture of ferritic stainless steel and austenitic stainless steel, the ferritic stainless steel and the duplex stainless steel each having a pitting potential higher than or equal to 0.3 V vs. Ag/AgCl; and welding a pipe connection portion to the main body, the pipe connection portion being made of ferritic stainless steel, austenitic stainless steel, or duplex stainless steel that is a mixture of ferritic stainless steel and austenitic stainless steel, the ferritic stainless steel, the austenitic stainless steel, and the duplex stainless steel each having a pitting potential higher than or equal to 0.3 V vs. Ag/AgCl.

A water heater according to still another embodiment of the present disclosure includes the above hot water tank; a circulation water circuit in which water circulates as a heat medium; and a tap water circuit in which tap water circulates as a heat medium.

### Advantageous Effects of Invention

The hot water tank according to the embodiment of the present disclosure includes a weld formed by welding of the main body and the first part to each other. The body is made of a corrosion-resistant material other than austenitic stainless steel. It is therefore possible to maintain the corrosion resistance of the weld while reducing the manufacturing cost of the hot water tank.

### BRIEF DESCRIPTION OF DRAWINGS

FIG. 1 is a schematic configuration diagram of a water heater according to Embodiment 1.

FIG. 2 is a schematic configuration diagram of a hot water tank according to Embodiment 1.

FIG. 3 indicates an example of a measurement result of pitting potential.

FIG. 4 is a flowchart illustrating manufacturing steps of the hot water tank according to Embodiment 1.

FIG. 5 is an explanatory view for a gap between a main body and a pipe connection, at a main-body weld of the hot water tank according to Embodiment 1.

FIG. 6 is an explanatory view for a leg part of a hot water tank according to Embodiment 2.

FIG. 7 is an explanatory view for another example of the leg part of the hot water tank according to Embodiment 2.

FIG. 8 is an explanatory view for a further example of each of leg parts of the hot water tank according to Embodiment 2.

FIG. 9 illustrates still another example of the leg part of the hot water tank according to Embodiment 2.

### DESCRIPTION OF EMBODIMENTS

A hot water tank, a method for manufacturing the hot water tank, and a water heater according to the embodiments of the present disclosure will be described with reference to the drawings. The present disclosure is not limited to embodiments described below. Various modifications can be made without departing from the gist of the present disclosure. The present disclosure may encompass all possible combinations of configurations as described regarding the embodiments below. In the following descriptions, terms indicating directions (for example, “upper”, “lower”, “right”, and “left”) are used as appropriate in order that the embodiments and modifications be more easily understood, and do not intended to limit the present disclosure. In each of figures, components that are the same as or equivalent to those in a previous figure or previous figures are denoted by the same reference signs. The same is true of the entire text of the specification. It should be noted that in each of the figures, a relationship or relationships in relative dimension between components or a shape or shapes thereof may differ from actual ones.

### Embodiment 1

### Configuration of Water Heater

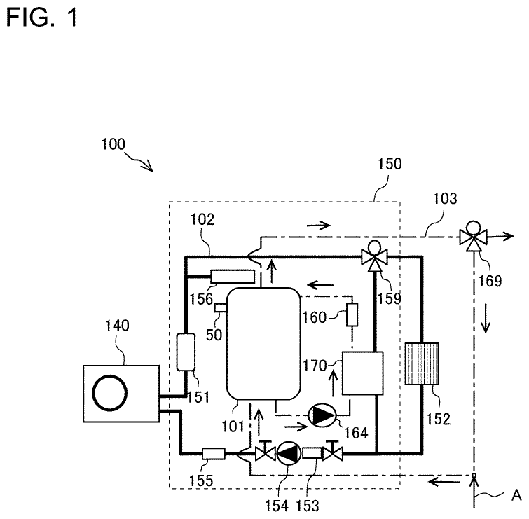

FIG. 1 is a schematic configuration diagram of a water heater 100 according to Embodiment 1. In FIG. 1, solid lines indicate a circulation water circuit 102, and dash-dotted lines indicate a tap water circuit 103. Also, solid arrows in FIG. 1 indicate flow directions of tap water in the tap water circuit 103.

As illustrated in FIG. 1, the water heater 100 includes a hot water tank 101, the circulation water circuit 102, and the tap water circuit 103. The circulation water circuit 102 is configured such that an outdoor unit 140, a booster heater 151, a radiator 152, a strainer 153, a circulation-water-circuit pump 154, a flowmeter 155, an expansion vessel 156, a plate heat exchanger 170, and a first three-way valve 159 are connected by pipes. The booster heater 151, the strainer 153, the circulation-water-circuit pump 154, the flowmeter 155, the expansion vessel 156, the plate heat exchanger 170, and the first three-way valve 159 are provided inside an indoor unit 150.

In the circulation water circuit 102, water circulates as a heat medium. The circulation-water-circuit pump 154 causes the water in the circulation water circuit 102 to circulate. The outdoor unit 140 includes therein a refrigerant circuit (not illustrated) in which refrigerant circulates. The water that circulates in the circulation water circuit 102 is heated in the outdoor unit 140 through heat exchange with refrigerant. The water that circulates in the circulation water circuit 102 is also heated by the booster heater 151. The water heated by the refrigerant and the booster heater 151 flows into the first three-way valve 159.

The first three-way valve 159 switches a flow passage for the water that circulates in the circulation water circuit 102 between multiple flow passages. More specifically, the water heated by the booster heater 151 is allowed by the first three-way valve 159 to flow into at least one of the plate heat exchanger 170 and the radiator 152.

In the plate heat exchanger 170, the water that flows in the circulation water circuit 102 and the tap water that flows in the tap water circuit 103 exchange heat with each other. T the tap water that flows in the tap water circuit 103 is heated by the water that has flowed from the first three-way valve 159 into the plate heat exchanger 170 in the circulation water circuit 102.

The radiator 152 is provided outside the indoor unit 150 to heat the indoor space. The water that has flowed from the first three-way valve 159 into the radiator 152 and flows in the circulation water circuit 102 transfers heat to the indoor air in the radiator 152. It should be noted that the device provided outside the indoor unit 150 to heat the indoor space may be a device other than the radiator 152. For example, a floor heating device may be installed instead of the radiator 152.

The water that circulates in the circulation water circuit 102 flows into the strainer 153 after transferring heat in the plate heat exchanger 170 or the radiator 152. In the circulation water circuit 102, iron rust particles and other foreign matter generated in the radiator 152 and other areas may sometimes enter the first three-way valve 159, together with the water that circulates in the circulation water circuit 102. Such iron rust particles and other foreign matter may damage the first three-way valve 159. The strainer 153 serves to remove the iron rust particles and other foreign matter from the water that circulates in the circulation water circuit 102.

Water that flows out from the strainer 153 flows into the outdoor unit 140 through the flowmeter 155. In the circulation water circuit 102, the expansion vessel 156 may be provided between the booster heater 151 and the first three-way valve 159. The expansion vessel 156 absorbs expansion water that has been generated.

The tap water circuit 103 is configured such that the hot water tank 101, a tap-water-circuit pump 164, the plate heat exchanger 170, a descaling device 160, and a second three-way valve 169 are connected by pipes. The hot water tank 101 may be provided with a pressure relief valve 50. The hot water tank 101, the tap-water-circuit pump 164, the plate heat exchanger 170, and the descaling device 160 are provided in the indoor unit 150.

In the tap water circuit 103, tap water flows as a heat medium. The tap water may either circulate in the tap water circuit 103 or flow out of the water heater 100. Whether the tap water circulates in the tap water circuit 103 or flows out of the water heater 100 depends on the state of the second three-way valve 169.

As indicated by the solid arrow A in FIG. 1, tap water flows into the tap water circuit 103 from the outside. The tap water that has flowed into the tap water circuit 103 flows from lower part of the hot water tank 101 into the hot water tank 101. The tap water that has flowed into the hot water tank 101 flows out from the hot water tank 101 from part of the lower part of the hot water tank 101 that is different from part thereof where the tap water has flowed into the hot water tank 101, and is then transferred to the plate heat exchanger 170 by the tap-water-circuit pump 164. The tap water that has been transferred to the plate heat exchanger 170 and flows in the tap water circuit 103 is heated through heat exchange with water that flows in the circulation water circuit 102.

The tap water that has been heated in the plate heat exchanger 170 and flows in the tap water circuit 103 flows into upper part of the hot water tank 101 through the descaling device 160. The descaling device 160 removes scaling ions such as calcium ions, magnesium ions, and ionic silica contained in the tap water that flows in the tap water circuit 103. Scaling ions are more easily precipitated as the temperature of the tap water rises. Thus, as the tap water heated in the plate heat exchanger 170 passes through the descaling device 160, scaling ions are easily removed. Furthermore, if scaling ions are precipitated in the plate heat exchanger 170, they deteriorates the heat exchange performance and blocks the flow passage in the plate heat exchanger 170. However, from tap water that re-flows into the hot water tank 101 after being heated in the plate heat exchanger 170, scaling ions are removed. It is therefore possible to prevent occurrence of precipitation of scaling ions in the plate heat exchanger 170 in the case where the tap water that has returned to the hot water tank 101 is re-transferred to the plate heat exchanger 170 by the tap-water-circuit pump 164. Thus, it is possible to protect the plate heat exchanger 170 by removal of scaling ions that is achieved by the descaling device 160.

The heated tap water that has flowed into the upper part of the hot water tank 101 through the descaling device 160 flows out from part of the upper part of the hot water tank 101 that is different from part thereof where the tap water has flowed into the hot water tank 101. The heated tap water that has flowed out from the hot water tank 101 flows out from the water heater 100 to the outside thereof through the second three-way valve 169. The tap water that has flowed out to the outside of the water heater 100 is supplied to, for example, a shower room, a lavatory, and a kitchen.

The second three-way valve 169 switches the flow passage for water that circulates in the tap water circuit 103. To be more specific, after flowing out from the hot water tank 101, the heated tap water is caused by the second three-way valve 169 to flow to at least one of the outside of the water heater 100 and the tap water circuit 103.

When the second three-way valve 169 does not cause the flow passage for the tap water to communicate with the outside, the flow passage for the tap water communicates with the tap water circuit 103. In this case, the tap water heated in the hot water tank 101 circulates in the tap water circuit 103. Thus, after passing through the second three-way valve 169, the tap water heated in the hot water tank 101 joins tap water that flows into the tap water circuit 103 from the outside. The tap water that has flowed from the outside and the heated tap water then flow together into the hot water tank 101.

### Configuration of Hot Water Tank

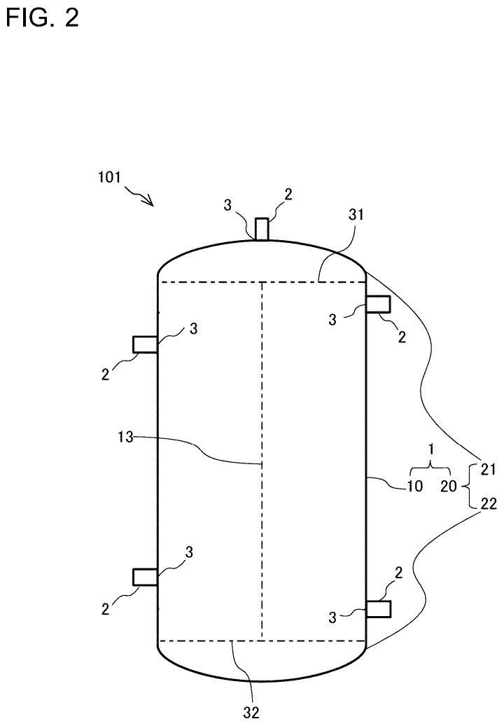

The hot water tank 101 according to Embodiment 1 will be described with reference to FIG. 2. FIG. 2 is a schematic configuration diagram of the hot water tank 101 according to Embodiment 1. The hot water tank 101 includes a main body 1, pipe connection portions 2, and main-body welds 3 that are formed by welding of the main body 1 and the pipe connection portions 2.

The main body 1 includes a tank body 10 having a cylindrical shape, and tank heads 20 provided to cover both ends of the tank body 10. The tank heads 20 are a first tank head 21 provided at one end of the tank body 10 and a second tank head 22 provided at the other end of the tank body 10. In the following description, the first tank head 21 and the second tank head 22 may each be referred to as the tank head 20 when it is not necessary to distinguish between the first tank head 21 and the second tank head 22.

The tank body 10 and the tank head 20 are each made of a corrosion-resistant material that is different in corrosion resistance from austenitic stainless steel. The corrosion-resistant material different in corrosion resistance from austenitic stainless steel is ferritic stainless steel or duplex stainless steel that is a mixture of ferritic stainless steel and austenitic stainless steel, the ferritic stainless steel and the duplex stainless steel each having a pitting potential higher than or equal to 0.3 V vs. Ag/AgCl. In the following description, the ferritic stainless steel, the austenitic stainless steel, and the duplex stainless steel that is a mixture of the ferritic stainless steel and the austenitic stainless steel may each be referred to as stainless steel when it is necessary to distinguish between the ferritic stainless steel, the austenitic stainless steel, and the duplex stainless steel that is a mixture of the ferritic stainless steel and the austenitic stainless steel. In addition, the duplex stainless steel that is a mixture of the ferritic stainless steel and the austenitic stainless steel will be sometimes referred to as duplex stainless steel.

The tank body 10 is formed into a cylindrical shape by welding of plate-shaped ferritic stainless steel or plate-shaped duplex stainless steel, the plate-shaped ferritic stainless steel and the plate-shaped duplex stainless steel each having a pitting potential higher than or equal to 0.3 V vs. Ag/AgCl. Part of the tank body 10 where the plate-shaped stainless steel is welded is a tank-body weld 13. Furthermore, the tank body 10 and the first tank head 21 are welded to each other, and the tank body 10 and the second tank head 22 are also welded to each other. A weld at which the tank body 10 and the first tank head 21 are welded to each other is a first tank head weld 31, and a weld where the tank body 10 and the second tank head 22 are welded to each other is a second tank head weld 32. The tank-body weld 13 extends between the first tank head 21 and the second tank head 22 in a direction perpendicular to the circumferential direction of the cylindrical shape. The first tank head weld 31 and the second tank head weld 32 extend in the circumferential direction of the cylindrical shape. All the tank body 10, the first tank head 21, and the second tank head 22 may be made of the same stainless steel. Alternatively, any one of these components may be made of ferritic stainless steel, and the others of the components may be made of duplex stainless steel.

The pipe connection portions 2 are each made of ferritic stainless steel, austenitic stainless steel, or duplex stainless steel that is a mixture of ferritic stainless steel and austenitic stainless steel, the ferritic stainless steel, the austenitic stainless steel, and the duplex stainless steel each having a pitting potential higher than or equal to 0.3 V vs. Ag/AgCl. At the pipe connection portions 2, pipes that form the tap water circuit 103 (see FIG. 1) and through which tap water flows are connected to the hot water tank 101. The pipe connection portions 2 may be part of the pipes in the tap water circuit 103, or may be joints to which the pipes in the tap water circuit 103 are connected. The pipe connection portion portions 2 may be part of pipes other than the pipes in the tap water circuit 103. The joint corresponding to each of the pipe connection portions 2 is, for example, a threaded boss joint or a fastener joint. The joint corresponding to the pipe connection portion 2 may be connected to, for example, the pressure relief valve 50 (see FIG. 1). Although FIG. 2 depicts five pipe connection portions 2 as an example, the number of pipe connection portions 2 is not particularly limited. The number of pipe connection portions 2 may be one, or may be five or more. The pipe connection portions 2 may be each located anywhere at the main body 1. That is, the pipe connection portions 2 may be located at any part of the following components: the tank body 10, the first tank head 21, and the second tank head 22. However, in the case where each of the pipe connection portions 2 is located at part made of ferritic stainless steel, the pipe connection portion 2 is made of material including austenitic stainless steel. It should be noted that the material including austenitic stainless steel corresponds to austenitic stainless steel and duplex stainless steel that is a mixture of ferritic stainless steel and austenitic stainless steel.

The main-body welds 3 are formed by welding of the main body 1 and the pipe connection portions 2. Each of the main-body welds 3 will be described later in detail.

### Pitting Potential of Hot Water Tank

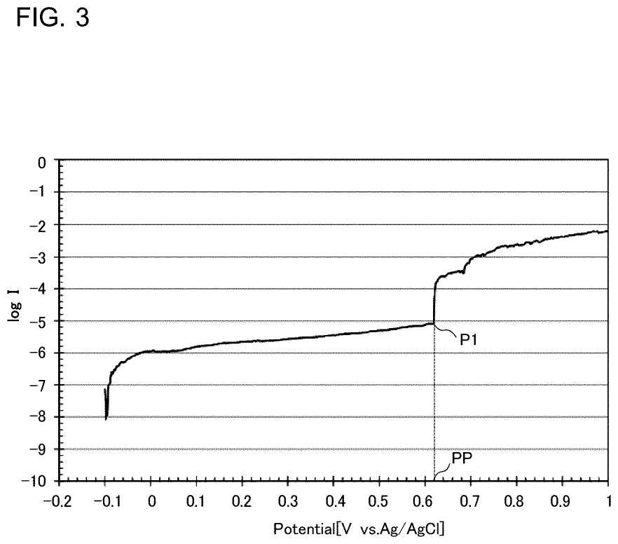

FIG. 3 indicates an example of a measurement result of pitting potential. FIG. 3 indicates an example of variation of the value of current that flows during voltage sweeping. In FIG. 3, the horizontal axis represents the potential obtained during sweeping, and the vertical axis represents the common logarithm of the current value. In the example of the measurement result in FIG. 3, silver and silver chloride (Ag/AgCl) are used as a reference electrode.

It is possible to measure the pitting potential by performing electrochemical measurement on a metallic material. Potential sweeping in the positive or negative direction is performed for the metallic material to measure the potential dependence and reaction rate of oxidation-reduction reactions occurring on an electrode. At this time, the metallic material is used as the electrode. The pitting potential can be measured by methods that use an electrochemical measurement device such as a potentiostat, and that include the method specified in “JIS G 0577:2014, Method for Measuring Pitting Potential of Stainless Steels,” and also under test conditions that are applied in consideration of the operating specifications of a water heater including a hot water tank and the water quality at the installation site.

In FIG. 3, the current value abruptly rises at point P1. Ferritic stainless steel, austenitic stainless steel, or duplex stainless steel that is a mixture of ferritic stainless steel and austenitic stainless steel has a passive film formed on its surface. Although the passive film is initially intact, as the potential is increased, the passive film is locally broken down, leading to formation of holes. In other words, pitting corrosion grows. The lower limit potential at which the pitting corrosion occurs and grows is referred to as pitting potential. In FIG. 3, “PP” represents an example of the pitting potential. In Embodiment 1, in the stainless steel that forms the main body 1, the pitting potential before welding is higher than or equal to 0.3 V vs. Ag/AgCl before welding. In addition, it is preferable that in the stainless steel that forms the pipe connection portion 2, the pitting potential before welding be higher than or equal to 0.3 V vs. Ag/AgCl.

The stainless steel that forms each of the main body 1 and the pipe connection portion 2 has high corrosion resistance due to formation of, on the surface of a metal, a passive film made mainly of chromium (Cr) in the metal. However, a large amount of heat is applied to the stainless steel during welding. This heat input history causes a phenomenon called sensitization in the stainless steel. Sensitization is a phenomenon in which the chromium (Cr) in the stainless steel decreases in concentration along the grain boundaries within the metal, increasing its susceptibility to stress corrosion cracking. When sensitization occurs, the corrosion resistance decreases. In Embodiment 1, the main-body welds 3, the tank-body weld 13, the first tank head weld 31, and the second tank head weld 32 are parts formed by welding. Thus, even if the pitting potential before welding is higher than or equal to 0.3 V vs. Ag/AgCl, the pitting potential after welding may decrease. In Embodiment 1, it is preferable that the main-body weld 3, the tank-body weld 13, the first tank head weld 31, and the second tank head weld 32 each have a pitting potential higher than or equal to 0.3 V vs. Ag/AgCl.

More specifically, it is preferable that with respect to each of the main-body weld 3, the tank-body weld 13, the first tank head weld 31, and the second tank head weld 32, part of each of these welds that comes into contact with water stored in the main body 1 have a pitting potential higher than or equal to 0.3 V vs. Ag/AgCl. It should be noted that of each of the above welds 3, 13, 31, and 32, part of the main body 1 that is located on an outer circumferential side of the main body 1 and that does not come into contact with water may have a pitting potential lower than 0.3 V vs. Ag/AgCl. Therefore, as long as the main body 1 and the pipe connection portion 2 are each made of stainless steel having a pitting potential higher than or equal to 0.3 V vs. Ag/AgCl, and the main-body weld 3, the tank-body weld 13, the first tank head weld 31, and the second tank head weld 32 each have a pitting potential higher than or equal to 0.3 V vs. Ag/AgCl at part of each of the above welds that comes into contact with water, it is possible to provide a hot water tank 101 capable of maintaining its corrosion resistance and a water heater 100 including such a hot water tank 101.

The welding method that is applied at the time of forming the main-body weld 3, the tank-body weld 13, the first tank head weld 31, and the second tank head weld 32 is not particularly limited. A suitable welding method may be selected on the basis of the shape of part that is subjected to welding, and welding conditions that are applied. As the welding methods, laser welding, tungsten inert gas (TIG) welding, and cold metal transfer (CMT) welding are present. From these welding methods, a suitable one can be selected.

However, regardless of which of the welding methods is selected, an oxide called oxide scale or weld discoloration may form on the surface of the resulting weld, though whether such an oxide forms or not depends on welding conditions applied. Therefore, after welding, so-called temper color adheres to each of the main-body weld 3, the tank-body weld 13, the first tank head weld 31, and the second tank head weld 32. Such an oxide may cause deterioration of the corrosion resistance of the hot water tank 101. Thus, at steps from a tank-body-weld pickling step S16 to a main-body-weld pickling step S19 that will be described later, a pickling process is executed to remove an oxide from the welded part. However, under some conditions for the pickling process, the pitting potential of the weld may decrease. For example, in the case where the pickling process is performed for a long period of time or in the case where the concentration of acid for use in the pickling process is high, the pitting potential of the weld may decrease. For this reason, in Embodiment 1, it is preferable that after being subjected to pickling, the main-body weld 3, the tank-body weld 13, the first tank head weld 31, and the second tank head weld 32 each have a pitting potential higher than or equal to 0.3 V vs. Ag/AgCl. More specifically, it is preferable that after being subjected to pickling, part of each of the main-body weld 3, the tank-body weld 13, the first tank head weld 31, and the second tank head weld 32 have a pitting potential higher than or equal to 0.3 V vs. Ag/AgCl, the above part being part that comes into contact with water stored in the main body 1. It should be noted that after being subjected to picking, part of each of the main-body weld 3, the tank-body weld 13, the first tank head weld 31, and the second tank head weld 32 may having a pitting potential lower than 0.3 V vs. Ag/AgCl, the above part being part that does not come into contact with water. Pickling may be either performed or not performed on the outer circumferential surface of the main body 1.

### Method for Manufacturing Hot Water Tank

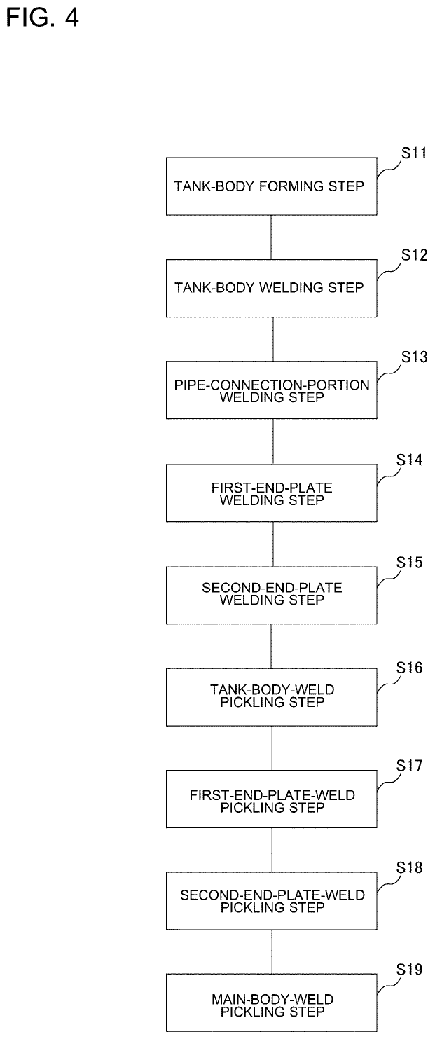

A method for manufacturing the hot water tank 101 will be described with reference to FIG. 4. FIG. 4 is a flowchart illustrating manufacturing steps of the hot water tank 101 according to Embodiment 1. As illustrated in FIG. 4, the method for manufacturing the hot water tank 101 includes a tank-body forming step S11, a tank-body welding step S12, a pipe-connection-portion welding step S13, a first tank-head welding step S14, a second tank-head welding step S15, a tank-body-weld pickling step S16, a first tank-head-weld pickling step S17, a second tank-head-weld pickling step S18, and a main-body-weld pickling step S19.

At the tank-body forming step S11, from a roll of stainless steel, a portion that will serve as the tank body 10 is cut out, and holes for connection of the pipe connection portions 2 are formed. The stainless steel that forms the tank body 10, that is, ferritic stainless steel or duplex stainless steel that is a mixture of ferritic stainless steel and austenitic stainless steel is sheet-like stainless steel. This sheet-like stainless steel is in the form of a coil rolled up and is referred to as coiled material. The ferritic stainless steel or duplex stainless steel that forms the tank body 10 has a pitting potential higher than or equal to 0.3 V vs. Ag/AgCl. At the tank-body forming step S11, the coiled material is cut to a predetermined length to form into a rectangular stainless steel plate from which the tank body 10 is to be formed. Next, holes for welding of the pipe connection portions 2 are formed in the resulting stainless steel plate. The holes are formed by cutting the stainless steel plate. The method for cutting the coiled material is not particularly limited. For example, the coiled material may be cut with a laser.

At the tank-body welding step S12, the stainless steel plate having the holes formed therein at the tank-body forming step S11 is rolled and bent to form into a cylindrical shape such that its longitudinal end portions are in contact with each other. These end portions of the stainless steel plate formed into the cylindrical shape are then welded, thereby forming the tank body 10 having the cylindrical shape. The part of the stainless steel plate that is welded corresponds to the tank-body weld 13. It is preferable that the pitting potential of the tank-body weld 13 be higher than or equal to 0.3 V vs. Ag/AgCl.

At the pipe-connection-portion welding step S13, the holes formed in the tank body 10 at the tank-body forming step S11 are enlarged by burring. The pipe connection portions 2 are then welded into the respective enlarged holes. The pipe connection portions 2 are made of ferritic stainless steel, austenitic stainless steel, or duplex stainless steel that is a mixture of ferritic stainless steel and austenitic stainless steel. Preferably, the ferritic stainless steel, the austenitic stainless steel, and the duplex stainless steel should have a pitting potential higher than or equal to 0.3 V vs. Ag/AgCl. In the case where the tank body 10 is made of ferritic stainless steel, the pipe connection portions 2 made of austenitic stainless steel or duplex stainless steel are welded to the tank body 10. The parts where the pipe connection portions 2 are welded into the holes formed in the tank body 10 correspond to the main-body welds 3. Preferably, the main-body welds 3 should have a pitting potential higher than or equal to 0.3 V vs. Ag/AgCl.

At the first tank-head welding step S14, the first tank head 21 is welded in the circumferential direction at one end of the tank body 10 having a cylindrical shape. The first tank head 21 is made of ferritic stainless steel, austenitic stainless steel, or duplex stainless steel that is a mixture of ferritic stainless steel and austenitic stainless steel, the ferritic stainless steel, the austenitic stainless steel, and the duplex stainless steel each having a pitting potential higher than or equal to 0.3 V vs. Ag/AgCl. The part where the first tank head 21 and the tank body 10 are welded to each other corresponds to the first tank head weld 31. Preferably, the pitting potential of the first tank head weld 31 should be higher than or equal to 0.3 V vs. Ag/AgCl. The tank body 10 and the first tank head 21 may be made of the same kind of stainless steel. Alternatively, one of the tank body 10 and the first tank head 21 may be made of ferritic stainless steel, and the other may be made of duplex stainless steel.

At the second tank-head welding step S15, the second tank head 22 is welded in the circumferential direction at the other end of the tank body 10 having a cylindrical shape. The second tank head 22 is made of ferritic stainless steel, austenitic stainless steel, or duplex stainless steel that is a mixture of ferritic stainless steel and austenitic stainless steel, the ferritic stainless steel, the austenitic stainless steel, and the duplex stainless steel each having a pitting potential higher than or equal to 0.3 V vs. Ag/AgCl. The part where the second tank head 22 and the tank body 10 are welded to each other corresponds the second tank head weld 32. Preferably, the pitting potential of the second tank head weld 32 should be higher than or equal to 0.3 V vs. Ag/AgCl. The tank body 10 and the second tank head 22 may be made of the same kind of stainless steel. Alternatively, one of the tank body 10 and the second tank head 22 may be made of ferritic stainless steel, and the other may be made of duplex stainless steel.

At the tank-body-weld pickling step S16, the tank-body weld 13 is subjected to pickling. From the tank-body weld 13 subjected to the pickling process, temper color is removed. Preferably, the tank-body weld 13 subjected to the pickling process should have a pitting potential higher than or equal to 0.3 V vs. Ag/AgCl.

At the first tank-head-weld pickling step S17, the first tank head weld 31 is subjected to pickling. From the first tank head weld 31 subjected to the picking, temper color is removed. Preferably, the pitting potential of the first tank head weld 31 subjected to the pickling should be higher than or equal to 0.3 V vs. Ag/AgCl.

At the second tank-head-weld pickling step S18, the second tank head weld 32 is subjected to pickling. From the second tank head weld 32 subjected to the pickling process, temper color is removed. Preferably, the pitting potential of the second tank head weld 32 subjected to the pickling should be higher than or equal to 0.3 V vs. Ag/AgCl.

At the main-body-weld pickling step S19, the main-body weld 3 is subjected to pickling. From the main-body weld 3 subjected to the pickling, temper color is removed. Preferably, the pitting potential of the main-body weld 3 subjected to pickling should be higher than or equal to 0.3 V vs. Ag/AgCl.

Although the steps described above do not include the step of connecting pipe connection portions 2 to the first tank head 21 and the second tank head 22, the pipe connection portions 2 may be welded to the first tank head 21 and the second tank head 22. The step of welding the pipe connection portions 2 to the first tank head 21 and the second tank head 22 is not particularly limited. At the first tank-head welding step S14 and the second tank-head welding step S15, the first tank head 21 and the second tank head 22 to which the pipe connection portions 2 have already been connected may be welded to the tank body 10. At the first tank-head welding step S14 and the second tank-head welding step S15, the first tank head 21 and the second tank head 22 having holes for connection of the pipe connection portions 2 are welded to the tank body 10. In this case, it suffices that at the first tank-head welding step S14 and the second tank-head welding step S15, the first tank head 21 and the second tank head 22 are welded to the tank body 10, and the pipe connection portions 2 are then welded to the first tank head 21 and the second tank head 22. In any case, at the main-body-weld pickling step S19, all the main-body welds 3 are subjected to pickling. That is, not only the main-body welds 3 at which the pipe connection portions 2 are welded to the tank body 10, but also the main-body welds 3 at which the pipe connection portions 2 are welded to the first tank head 21, and the main-body welds 3 at which the pipe connection portions 2 are welded to the second tank head 22 are subjected to pickling. It should be noted that the steps from the tank-body-weld pickling step S16 to the main-body-weld pickling step S19 may be interchanged in order. Furthermore, the steps from the tank-body pickling step S16 to the main-body-weld pickling step S19 may be carried out as a single pickling step, not as individual steps. That is, as a single pickling step, the tank-body weld 13, the first tank head weld 31, and the second tank head weld 32, and the main-body weld 3 may be subjected to pickling all at once. For example, by filling the hot water tank 101 with a pickling solution, it is possible to cause these welds to be subjected to pickling all at once.

### Main-Body Weld

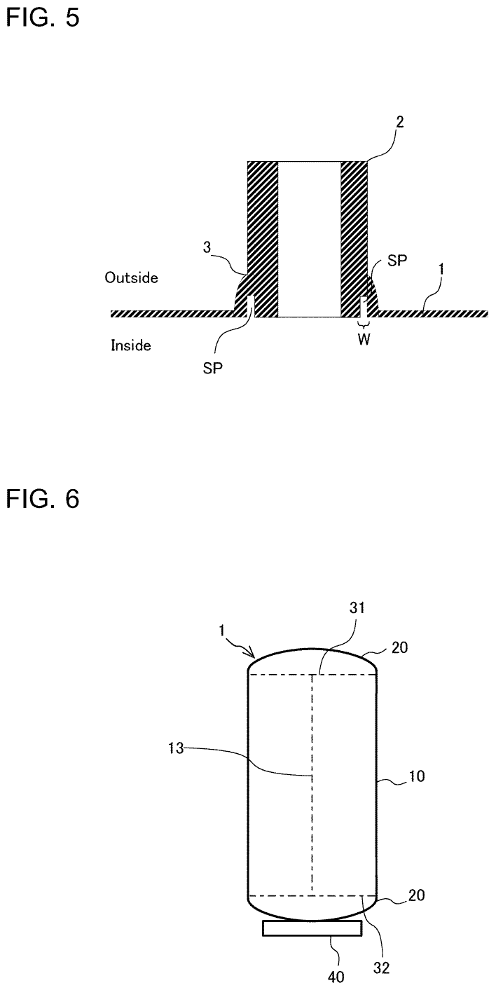

The main-body weld 3 will be described with reference to FIG. 5. FIG. 5 is an explanatory view for a gap SP between the main body 1 and the pipe connection portion 2, at the main-body weld 3 of the hot water tank 101 according to Embodiment 1. An area indicated as “Indside” in FIG. 3 is an area located inside the main body 1, and an area indicated as “Outside” in FIG. 3 is an area located outside the main body 1.

As described above with respect to the pipe-connection-portion welding step S13, for the tank body 10, the pipe connection portions 2 are welded into the holes enlarged by burring. As in the tank body 10, in the first tank head 21 and the second tank head 22, the pipe connection portions 2 are welded into holes enlarged by burring. The main-body welds 3 are formed by inserting and welding the pipe connection portions 2 into the holes provided in the main body 1, that is, the holes that are provided in the tank body 10, the first tank head 21, and the second tank head 22. At this time, in welding the main body 1 and the pipe connection portions 2 inserted in the hole sin the main body 1, in some cases, a gap SP as illustrated in FIG. 3 may be formed between the main body 1 and the pipe connection portion 2. In Embodiment 1, the main body 1 and the pipe connection portion 2 are welded such that the gap SP has a width W greater than 100 μm. The width W of the gap SP in this case is the length in the lateral direction in the plane of FIG. 3. Preferably, the width W of the gap SP should not be greater than the thickness of the main body 1. In any case, the width W of the gap SP is not greater than or equal to 10 mm. For example, the width W of the gap SP is greater than 100 μm but less than or equal to 2 mm.

In the case where the width W of the gap SP between the main body 1 and the pipe connection portion 2 is less than or equal to 100 μm, the supply of dissolved oxygen in the gap SP becomes insufficient, as compared with that in the external surroundings, resulting in a lower oxygen concentration. In this case, because of the difference in oxygen concentration, an oxygen concentration cell is formed, and a corrosion reaction of the stainless steel progresses. As a result, crevice corrosion at the main-body weld 3 may cause formation of a hole in the main body 1, leading to a potential water leak from the main body 1. Therefore, in Embodiment 1, the main body 1 and the pipe connection portion 2 are welded such that the width W of the gap SP does not fall at or below 100 μm. It should be noted that during welding of the main body 1 and the pipe connection portion 2, in some cases, stainless steel may melt and then solidify in such a shape that it extends across the main body 1 and the pipe connection portion 2. In other words, in some cases, the gap SP is formed in a space that is located outside the main body 1 prior to welding. Therefore, in Embodiment 1, the main body 1 and the pipe connection portion 2 are welded such that the width W of the gap SP formed as described above does not fall at or below 100 μm.

As described above, the hot water tank 101 according to Embodiment 1 includes the main body 1, the pipe connection portions 2 serving as first part, and welds formed by welding of the main body 1 and the pipe connection portions 2. The main body 1 is made of a corrosion-resistant material other than austenitic stainless steel. It is therefore possible to maintain the corrosion resistance of the weld while reducing the manufacturing cost of the hot water tank 101.

In the hot water tank 101 according to Embodiment 1, the corrosion-resistant material has a pitting potential higher than or equal to 0.3 V vs. Ag/AgCl. Therefore, the hot water tank 101 can maintain its corrosion resistance.

In the hot water tank 101 according to Embodiment 1, the first part is the pipe connection portions 2 that connect pipes to the main body 1, and the welds are the main-body welds 3 where the pipe connection portions 2 and the main body 1 are welded to each other. The pipe connection portions 2 are each made of a corrosion-resistant material other than austenitic stainless steel. It is therefore possible to maintain the corrosion resistance of the main-body welds 3 while reducing the manufacturing cost of the hot water tank 101.

The hot water tank 101 according to Embodiment 1 includes the main body 1, the pipe connection portions 2 that connect pipes to the main body 1, and the main-body welds 3 formed by welding of the pipe connection portions 2 and the main body 1. At least one of the main body 1 and each of the pipe connection portions 2 is made of material including austenitic stainless steel. The main body 1 is made of ferritic stainless steel or duplex stainless steel that is a mixture of ferritic stainless steel and austenitic stainless steel. The pipe connection portions 2 are made of ferritic stainless steel, austenitic stainless steel, or duplex stainless steel that is a mixture of ferritic stainless steel and austenitic stainless steel.

In the above configuration, in the case where the main body 1 is made of ferritic stainless steel, the pipe connection portions 2 are made of material including austenitic stainless steel. The material including austenitic stainless steel is austenitic stainless steel or duplex stainless steel. Therefore, in the case where the main body 1 is made of ferritic stainless steel, the pipe connection portions 2 are made of austenitic stainless steel or duplex stainless steel. On the other hand, in the case where the main body 1 is made of duplex stainless steel, the pipe connection portions 2 may be made of ferritic stainless steel. That is, in the case where the main body 1 is made of duplex stainless steel, the pipe connection portions 2 are made of ferritic stainless steel, austenitic stainless steel, or duplex stainless steel. As described above, in the hot water tank 101, at least one of the main body 1 and each of the pipe connection portions 2 is made of the material including austenitic stainless steel, whereby it is possible to maintain the corrosion resistance of the main-body weld 3.

The water heater 100 according to Embodiment 1 includes the hot water tank 101, the circulation water circuit 102 in which water circulates as a heat medium, and the tap water circuit 103 in which tap water circulates as a heat medium. The water heater 100 includes the hot water tank 101 capable of maintaining its corrosion resistance, thereby reducing the risk that damage to the hot water tank 101 may affect the performance and service life of the water heater 100.

In the hot water tank 101 according to Embodiment 1, the main-body weld 3 has a pitting potential higher than or equal to 0.3 V vs. Ag/AgCl. It is therefore possible to maintain the corrosion resistance of the main-body weld 3 at which the pipe connection portion 2 is welded to the main body 1.

In the hot water tank 101 according to Embodiment 1, the main body 1 includes the tank body 10 having a cylindrical shape, the first tank head 21 provided at one end of the tank body 10, and the second tank head 22 provided at the other end of the tank body 10. The tank body 10 is welded at the tank-body weld 13, which extends between the one end and the other end and in a direction perpendicular to the circumferential direction of the cylindrical shape. The tank body 10 and the first tank head 21 are welded at the first tank head weld 31, and the tank body 10 and the second tank head 22 are welded at the second tank head weld 32. The tank-body weld 13, the first tank head weld 31, and the second tank head weld 32 each have a pitting potential higher than or equal to 0.3 V vs. Ag/AgCl.

In the above configuration, the welded part of the main body 1 has a pitting potential higher than or equal to 0.3 V vs. Ag/AgCl. It is therefore possible to maintain the corrosion resistance of the welded part.

In the hot water tank 101 according to Embodiment 1, each of the main-body weld 3, the tank-body weld 13, the first tank head weld 31, and the second tank head weld 32 is in a pickled state, and has a pitting potential higher than or equal to 0.3 V vs. Ag/AgCl. It is therefore possible to maintain the corrosion resistance of the welded part subjected to pickling.

In the hot water tank 101 according to Embodiment 1, at the main-body weld 3, the gap SP greater than 100 μm is provided between the main body 1 and the pipe connection portion 2. It is therefore possible to reduce occurrence of crevice corrosion, and maintain corrosion resistance of the main-body weld 3.

The method for manufacturing the hot water tank 101 according to Embodiment 1 includes the step S11 of forming the main body 1 having the cylindrical tank body 10, using a coiled material of ferritic stainless steel or a coiled material of duplex stainless steel that is a mixture of ferritic stainless steel and austenitic stainless steel, the ferritic stainless steel and the duplex stainless steel each having a pitting potential higher than or equal to 0.3 V vs. Ag/AgCl. The method also includes the step S13 of welding each of the pipe connection portions 2 to the main body 1. The pipe connection portion 2 is made of ferritic stainless steel, austenitic stainless steel, or duplex stainless steel that is a mixture of ferritic stainless steel and austenitic stainless steel, the ferritic stainless steel, the austenitic stainless steel, and the duplex stainless steel each having a pitting potential higher than or equal to 0.3 V vs. Ag/AgCl.

In the above configuration, the hot water tank 101 is formed of stainless steel having a pitting potential higher than or equal to 0.3 V vs. Ag/AgCl, whereby it is possible to manufacture the hot water tank 101 having high corrosion resistance, even if variations in production occurs, such as in welding conditions.

The method for manufacturing the hot water tank 101 according to Embodiment 1 further includes the step S16 of pickling that tank-body weld 13 of the tank body 10 that is the weld at which the coiled material is welded and that has a pitting potential higher than or equal to 0.3 V vs. Ag/AgCl; the step S17 of pickling the first tank head weld 31 that is the weld between the tank body 10 and the first tank head 21 provided at one end of the tank body 10 and that has a pitting potential higher than or equal to 0.3 V vs. Ag/AgCl; and the step S18 of pickling the second tank head weld 32 that is the weld between the tank body 10 and the second tank head 22 provided at the other end of the tank body 10 and that has a pitting potential higher than or equal to 0.3 V vs. Ag/AgCl.

In the above configuration, the tank-body weld 13, the first tank head weld 31, and the second tank head weld 32 each having a pitting potential higher than or equal to 0.3 V vs. Ag/AgCl after welding are subjected to pickling. Since the tank-body weld 13, the first tank head weld 31, and the second tank head weld 32 each have a pitting potential higher than or equal to 0.3 V vs. Ag/AgCl before being subjected to pickling, it is possible to maintain the corrosion resistance of these welds after the pickling. It is therefore possible to manufacture the hot water tank 101 having high corrosion resistance.

### Embodiment 2

The following description concerning Embodiment 2 is made by referring mainly to the differences Embodiments 1 and 2. In Embodiment 2, the hot water tank 101 includes a leg part 40 provided at the main body 1. In this regard, Embodiment 2 is different from Embodiment 1. The other configurations of Embodiment 2 are the same as those of Embodiment 1, and their descriptions will thus be omitted.

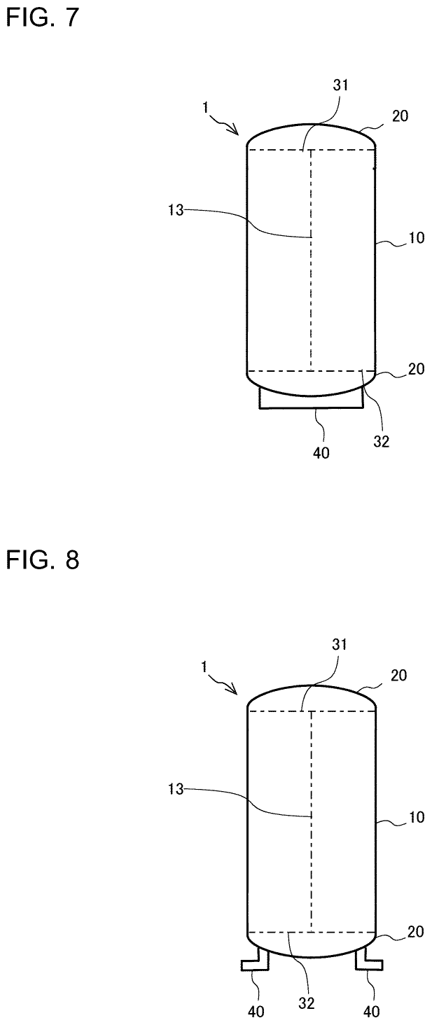

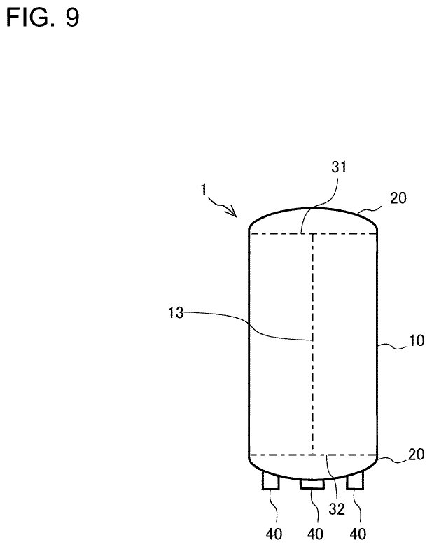

The leg part 40 according to Embodiment 2 will be described with reference to FIGS. 6 to 9. FIG. 6 is an explanatory view for the leg part 40 of the hot water tank 101 according to Embodiment 2. FIG. 7 is an explanatory view for another example of the leg part 40 of the hot water tank 101 according to Embodiment 2. FIG. 8 is an explanatory view for a further example of each of the leg parts 40 of the hot water tank 101 according to Embodiment 2. FIG. 9 is an explanatory view for still another example of each of the leg parts 40 of the hot water tank 101 according to Embodiment 2.

As illustrated in FIGS. 6 to 9, the hot water tank 101 includes the leg part 40 or leg parts 40 provided at the main body 1. The leg part or each of the leg parts 40 is made of ferritic stainless steel, austenitic stainless steel, or duplex stainless steel that is a mixture of ferritic stainless steel and austenitic stainless steel. The leg part 40 is provided to enable the main body 1 to stand independently. Therefore, the leg part 40 is provided at the tank head 20 that is the lower one of the first and second tank heads 21 and 22 in the direction of gravity. As long as the leg part 40 is fixed to the tank head 20 by the fixing method, the fixing method is not particularly limited. It is preferable, however, that the leg part 40 be fixed to the tank head 20 by welding. Also, in welding the leg part 40 and the tank head 20 to each other, preferably, at least one of the tank head 20 or the leg part 40 should be made of stainless steel including austenitic stainless steel. In the case where either the tank head 20 or the leg part 40 contains austenitic stainless steel, it is possible to provide the leg part 40 at the main body 1 without impairing the corrosion resistance of the hot water tank 101. The leg part 40 may have a pitting potential lower than 0.3 V vs. Ag/AgCl. However, in the case where an area at which the leg part 40 is welded is exposed on an inner circumferential side of the main body 1 to come into contact with water stored therein, it is preferable that the pitting potential of the area at which the leg part 40 is welded be higher than or equal to 0.3 V vs. Ag/AgCl.

The shape and the number of leg parts 40 are not particularly limited as long as the leg part or parts 40 are capable of supporting the main body 1 in such a manner as to allow the main body 1 to stand independently. As illustrated in FIG. 6, the leg part 40 may be in the shape of a plate having a flat surface to be placed on the ground. FIG. 6 illustrates an example in which a single plate-shaped leg part 40 is fixed to central part of the tank head 20. Furthermore, as illustrated in FIG. 7, a surface of the leg part 40 that is fixed to the tank head 20 may have a shape that conforms to the curved surface of the tank head 20. In addition, the leg part 40 is not necessarily singular and plural leg parts 40 may be provided as illustrated in FIGS. 8 and 9. FIG. 8 illustrates an example in which two leg parts 40 that are L-shaped as viewed side-on are fixed to the tank head 20. FIG. 9 illustrates an example in which three leg parts 40 are fixed to the tank head 20. As illustrated in FIG. 9, not all of the leg parts 40 need to have the same shape or the same size. The leg part or parts 40 may be made of material other than ferritic stainless steel, austenitic stainless steel, and duplex stainless steel.

### REFERENCE SIGNS LIST

1: main body, 2: pipe connection portion, 3: main-body weld, 10: tank body, 13: tank-body weld, 20: tank head, 21: first tank head, 22: second tank head, 31: first tank head weld, 32: second tank head weld, 40: leg part, 50: pressure relief valve, 100: water heater, 101: hot water tank, 102: circulation water circuit, 103: tap water circuit, 140: outdoor unit, 150: indoor unit, 151: booster heater, 152: radiator, 153: strainer, 154: circulation-water-circuit pump, 155: flowmeter, 156: expansion vessel, 159: first three-way valve, 160: descaling device, 164: tap-water-circuit pump, 169: second three-way valve, 170: plate heat exchanger, P1: point, PP: pitting potential example, SP: gap, W: width.

1. A hot water tank configured to store water including tap water, comprising:
a main body;
a first part;
a weld formed by welding of the main body and the first part to each other; and
a leg part provided under the main body to enable the main body to stand independently,
wherein part of the main body that comes into contact with the water is made of a corrosion-resistant material that is other than austenitic stainless steel and that has a pitting potential higher than or equal to 0.3 V vs. Ag/AgCl,
the leg part, unlike the main body, is made of ferritic stainless steel, austenitic stainless steel, or duplex stainless steel that is a mixture of ferritic stainless steel and austenitic stainless steel, and
the leg part and part of the main body that is located on an outer circumferential side of the main body and that does not come into contact with water have a pitting potential lower than 0.3 V vs. Ag/AgCl.

2. (canceled)

3. The hot water tank of claim 1, wherein
the first part is a pipe connection portion that connects a pipe to the main body,
the weld is a main-body weld formed by welding of the pipe connection portion and the main body to each other, and
the pipe connection portion is made of the corrosion-resistant material.

4. A hot water tank configured to store water including tap water, comprising:
a main body;
a pipe connection portion that connects a pipe to the main body;
a main-body weld formed by welding of the pipe connection portion and the main body to each other; and
a leg part provided under the main body to enable the main body to stand independently,
wherein
at least one of the main body and the pipe connection portion is made of material including austenitic stainless steel,
the main body is made of ferritic stainless steel or duplex stainless steel that is a mixture of ferritic stainless steel and austenitic stainless steel,
the pipe connection portion is made of ferritic stainless steel, austenitic stainless steel, or duplex stainless steel that is a mixture of ferritic stainless steel and austenitic stainless steel,
the main-body weld has a pitting potential higher than or equal to 0.3 V vs. Ag/AgCl,
the leg part, unlike the main body, is made of ferritic stainless steel, austenitic stainless steel, or duplex stainless steel that is a mixture of ferritic stainless steel and austenitic stainless steel, and
the leg part and part of the main body that is located on an outer circumferential side of the main body and that does not contact with the water have a pitting potential lower than 0.3 V vs. Ag/AgCl.

5. The hot water tank of claim 3, wherein the main-body weld has a pitting potential higher than or equal to 0.3 V vs. Ag/AgCl.

6. The hot water tank of claim 3, wherein the main-body weld is in a pickled state and has a pitting potential higher than or equal to 0.3 V vs. Ag/AgCl.

7. The hot water tank of claim 3, wherein
the main body includes
a tank body having a cylindrical shape,
a first tank head provided at one end of the tank body, and
a second tank head provided at an other end of the tank body,
the tank body is welded at a tank-body weld that extends between the one end and the other end of the tank body and in a direction perpendicular to a circumferential direction of the cylindrical shape,
the tank body and the first tank head are welded to each other at a first tank head weld,
the tank body and the second tank head are welded to each other at a second tank head weld, and
the tank-body weld, the first tank head weld, and the second tank head weld each have a pitting potential higher than or equal to 0.3 V vs. Ag/AgCl.

8. The hot water tank of claim 7, wherein
the tank-body weld, the first tank head weld, and the second tank head weld are in a pickled state, and
the tank-body weld, the first tank head weld, and the second tank head weld each have a pitting potential higher than or equal to 0.3 V vs. Ag/AgCl.

9. The hot water tank of claim 3, wherein at the main-body weld, a gap greater than 100 μm is provided between the main body and the pipe connection portion.

10. (canceled)

11. A method for manufacturing a hot water tank configured to store water including tap water, the method comprising:
selecting a coiled material of ferritic stainless steel or a coiled material of duplex stainless steel that is a mixture of ferritic stainless steel and austenitic stainless steel, the ferritic stainless steel and the duplex stainless steel each having a pitting potential higher than or equal to 0.3 V vs. Ag/AgCl;
forming a main body that has a tank body having a cylindrical shape, using the selected coiled material having the pitting potential higher than or equal to 0.3 V vs. Ag/AgCl;
preparing a pipe connection portion made of ferritic stainless steel, austenitic stainless steel, or duplex stainless steel that is a mixture of ferritic stainless steel and austenitic stainless steel, the ferritic stainless steel, the austenitic stainless steel, and the duplex stainless steel each having a pitting potential higher than or equal to 0.3 V vs. Ag/AgCl;
welding the prepared pipe connection portion having the pitting potential higher than or equal to 0.3 V vs. Ag/AgCl to the main body; and
fixing a leg part provided below the main body to enable the main body to stand independently, unlike the main body, the leg part being made of ferritic stainless steel, austenitic stainless steel, or duplex stainless steel that is a mixture of ferritic stainless steel and austenitic stainless steel.

12. The method of claim 11 for manufacturing a hot water tank, the method comprising:
pickling a tank-body weld of the tank body that is a weld at which the coiled material is welded, the tank-body weld having a pitting potential higher than or equal to 0.3 V vs. Ag/AgCl;
pickling a first tank head weld between the tank body and a first tank head provided at one end of the tank body, the first tank head weld having a pitting potential higher than or equal to 0.3 V vs. Ag/AgCl; and
pickling a second tank head weld between the tank body and a second tank head provided at an other end of the tank body, the second tank head weld having a pitting potential higher than or equal to 0.3 V vs. Ag/AgCl.

13. A water heater comprising:
the hot water tank of claim 1;
a circulation water circuit in which water circulates as a heat medium; and
a tap water circuit in which tap water circulates as a heat medium.
